(19) United States
(12) Patent Application Publication
(10) Pub. No.: US 2024/0364157 A1
(43) Pub. Date: Oct. 31, 2024

(54) ELECTRIC AXIAL FLUX MACHINE, AND COLLABORATIVE ROBOT COMPRISING AN ELECTRIC AXIAL FLUX MACHINE

(71) Applicant: Schaeffler Technologies AG & Co. KG, Herzogenaurach (DE)

(72) Inventors: Jorg Kegeler, Schleusingen (DE); Andre Sporer, Suhl (DE); Ralf Schnabel, Suhl (DE); Karsten Feindt, Amt Wachsenburg (DE)

(73) Assignee: Schaeffler Technologies AG & Co. KG, Herzogenaurach (DE)

(21) Appl. No.: 18/563,522

(22) PCT Filed: May 2, 2022
(86) PCT No.: PCT/DE2022/100329

§ 371 Date: Nov. 22, 2023

(30) Foreign Application Priority Data
May 27, 2021 (DE) 10 2021 113 660.1

(51) Int. Cl. H02K 1/2798; B25J 9/12; H02K 21/24

(52) U.S. Cl. CPC H02K 1/2798; B25J 9/126; H02K 21/24; H02K 2213/03

(57) ABSTRACT

An electric axial flux machine having a disc-shaped rotor with a main part and P magnetic poles, which are arranged along the circumferential direction of the main part in a mutually spaced manner by an identical pole pitch and having a disc-shaped stator with Z teeth, wherein the P magnetic poles are arranged along the circumferential direction so as to have a first pole width and a second pole width in an alternating manner. The disclosure additionally relates to a collaborative robot.

### CROSS-REFERENCE TO RELATED APPLICATIONS

This application is the U.S. National Phase of PCT Appln. No. PCT/DE2022/100329, filed May 2, 2022, which claims the benefit of German Patent Appln. No. 102021113660.1, filed May 27, 2021 the entire disclosures of which are incorporated by reference herein.

### TECHNICAL FIELD

The disclosure relates to an electric axial flux machine and a collaborative robot having an electric axial flux machine.

### BACKGROUND

Electric axial flux machines are interesting candidates for the use of electrical machines in confined spaces. Typically, electric axial flux machines have one or more disc-shaped stators and one or more disc-shaped rotors arranged in the axial direction. The magnetic flux of the electric axial flux machine is arranged in the axial direction. If the rotor is arranged in the axial direction between two stators, it is called an internal rotor machine; if the rotor is arranged on the outside, it is called an external rotor machine.

Compared to radial flux machines, significantly shorter dimensions in the axial direction with the same performance are possible with axial flux machines. The compact design and the associated high power density make electric axial flux machines popular alternatives in consumer electronics, in the field of automotive engineering and in particular in automation engineering.

The rotor and the stator of the electric axial flux machine usually have magnetic poles or armature teeth, or teeth for short. During operation of the electric axial flux machine, the relative movement of teeth and magnetic poles results in the fact that a tooth or a groove base arranged between two teeth is alternately arranged opposite a magnetic pole. The magnetic resistance and thus the driving force of the electric axial flux machine varies, which leads to unsteady running. This is known to those skilled in the art as pole sensitivity, cogging torque or cogging.

U.S. 10 566 866 B2 discloses providing permanent magnets on the rotor to reduce pole sensitivity in an axial flux machine, each of which is separated from one another by different distances in the circumferential direction of the rotor. However, this results in a reduced occupancy of the rotor with permanent magnets so the torque of the axial flux machine is reduced.

### SUMMARY

Against this background, the object is to provide are electric axial flux machine which the pole sensitivity is significantly reduced at high torque.

To achieve this object, an electric axial flux machine according to claim 1 is proposed. The electric axial flux machine according to the disclosure comprises a disc-shaped rotor with a main part and with P magnetic poles, which are each arranged spaced apart in a circumferential direction of the main part by an identical pole pitch, and a disc-shaped stator with Z teeth, the P magnetic poles being arranged in the circumferential direction in an alternating manner with a first pole width and a second pole width.

The electric axial flux machine according to the disclosure is significantly less pole-sensitive due to the alternatingly provided pole widths of the magnetic poles in the rotor. In addition, it becomes possible at the same time to provide identical distances between the poles of the stator, which can be dimensioned so small that the torque of the electric axial flux machine is only marginally affected.

Preferably, P is even.

The pole pitch of the magnetic poles in the sense of the present disclosure refers to the spacing, in relation to the circumferential direction, between the centers of two magnetic poles which are adjacent in the circumferential direction.

Advantageous embodiments and further developments of the disclosure can be found in the dependent claims and the description with reference to the drawings.

According to an advantageous embodiment of the disclosure, it is possible for the first pole width (6) to be in a range of 0.9[360°/p+(360°/LCM)*0.5] to 1.1[360°/p+(360°/LCM)*0.5] and for the second pole width (7) to be in a range of 0.9[360°/p−(360°/LCM)*0.5] to 1.1[360°/p−(360°/LCM)*0.5]. where P is greater than or equal to 4 and U is greater than or equal to 4 and not equal to P, and LCM is the least common multiple of P and Z. Such an embodiment of the rotor has proven to be particularly advantageous for reducing pole sensitivity. The first pole width (6) [360/p+(360°/LCM)*0.5] is preferred and the second pole width (7) is [360°/p−(360°/LCM)*0.5], where P is greater than or equal to 4 and U is greater than or equal to 4 and not equal to P, and LCM is the least common multiple of P and Z.

According to a preferred embodiment of the disclosure, the magnetic poles are formed by permanent magnets embedded in the main part of the rotor, the permanent magnets having magnetization in the circumferential direction of the rotor. With such an embodiment, a high degree of accuracy in the arrangement of the magnetic poles on the rotor can be made possible. The permanent magnets can generate a magnetic flux in the circumferential direction of the rotor, which emerges from one end face, preferably at two end faces, of the disc-shaped rotor. In this respect, the magnetic pole is defined by a position between two adjacent permanent magnets of the rotor. The pole width of such a magnetic pole is defined by the distance between adjacent permanent magnets. In such an embodiment, preferably the rotor is arranged between two stators in the manner of an internal rotor.

According to an alternatively preferred embodiment, the magnetic poles are formed by permanent magnets arranged at an end face of the rotor, in particular circular sector-shaped or circular ring sector-shaped permanent magnets. In such an embodiment, the magnetic poles are each formed by a permanent magnet. The pole width therefore corresponds to the width of the permanent magnet in the circumferential direction of the stator. The permanent magnets are preferably magnetized in an axial direction, i.e., parallel to an axis of rotation of the rotor.

According to an advantageous further embodiment of the disclosure, the main part is provided as a pressed part. This advantageously makes it possible to provide the recesses for receiving the magnetic poles in a material-saving manner, i.e., without or with significantly reduced subsequent material-removing machining.

According to an advantageous further embodiment of the disclosure, the main part is provided as an iron core. The main part is preferably made from Somaloy®. This makes it possible to improve the efficiency of the electric axial flux machine in an advantageous manner. Somaloy offers low hysteresis losses and can be easily processed as a pressed part. The main part particularly preferably has Somaloy® 5P. This enables particularly low hysteresis losses. It is also conceivable for the main part to have Somaloy® 3P. This enables a mechanically extremely robust main part that can withstand even the strongest mechanical influences. Furthermore, it is conceivable for the main part to have Somaloy® 1P. The main part particularly preferably has a mixture of Somaloy® 1P and Somaloy® 5P. It is also conceivable for the main part to be a mixture of Somaloy® 1P and Somaloy® 3P or a mixture of Somaloy® 1P, Somaloy® 5P and Somaloy® 3P.

According to an advantageous further embodiment of the disclosure, the magnetic poles are provided as cuboid magnets. This makes it possible to produce the electric axial flux machine significantly more cheaply. By using cuboid magnets, trapezoidal magnets in particular can be dispensed with. Preferably, the cuboid magnets are cuboid permanent magnets.

According to an advantageous further embodiment of the disclosure, the cuboid magnets are arranged in a spoke-like manner in the main part. The spoke-like arrangement enables a significant increase in the magnetic flux. In the context of the present disclosure, spoke-like means that the cuboid magnets are arranged in a radial direction in the main part.

According to an advantageous further embodiment of the disclosure, all cuboid magnets are the same size. This enables very cost-effective production of the electric axial flux machine. By using magnets of the same size, the manufacturing process is simplified and the amount of different parts is reduced. This directly reduces manufacturing costs.

According to an advantageous further embodiment of the disclosure, P=14 and Z=12. This number of magnetic poles and teeth is known for high pole sensitivity in conventional electric axial flux machines, in particular in the 6th harmonic of the mechanical rotation frequency of the electric axial flux machines. However, the electric axial flux machine according to this advantageous embodiment of the disclosure has only low pole sensitivity.

According to an advantageous further embodiment of the disclosure, the disc-shaped stator has printed conductor tracks. This enables very cost-effective series production of the electric axial flux machine.

The disclosure also relates to a collaborative robot having an electric axial flux machine according to the disclosure. By using the electric axial flux machine according to the disclosure, highly precise movement sequences of the collaborative robot are possible. Uneven running of the electric axial flux machine is largely prevented, which means that even very fine work can be done with the collaborative robot.

All details, features and advantages previously disclosed in connection with the electric axial flux machine according to the disclosure also relate to the collaborative robot according to the disclosure.

### BRIEF DESCRIPTION OF THE DRAWINGS

Further details and advantages of the disclosure are explained below with reference to the exemplary embodiment shown in the drawing. In the drawing:

FIG. 1 (a) shows a first exemplary embodiment of an electric axial flux machine according to the disclosure in a schematic representation.

FIG. 1 (b) shows a rotor of an exemplary embodiment of an electric axial flux machine according to the disclosure in a schematic representation.

FIG. 2 shows a second exemplary embodiment of an electric axial flux machine according to the disclosure in a schematic representation.

FIG. 3 shows an exemplary embodiment of a collaborative robot of according to the disclosure in a schematic representation.

### DETAILED DESCRIPTION

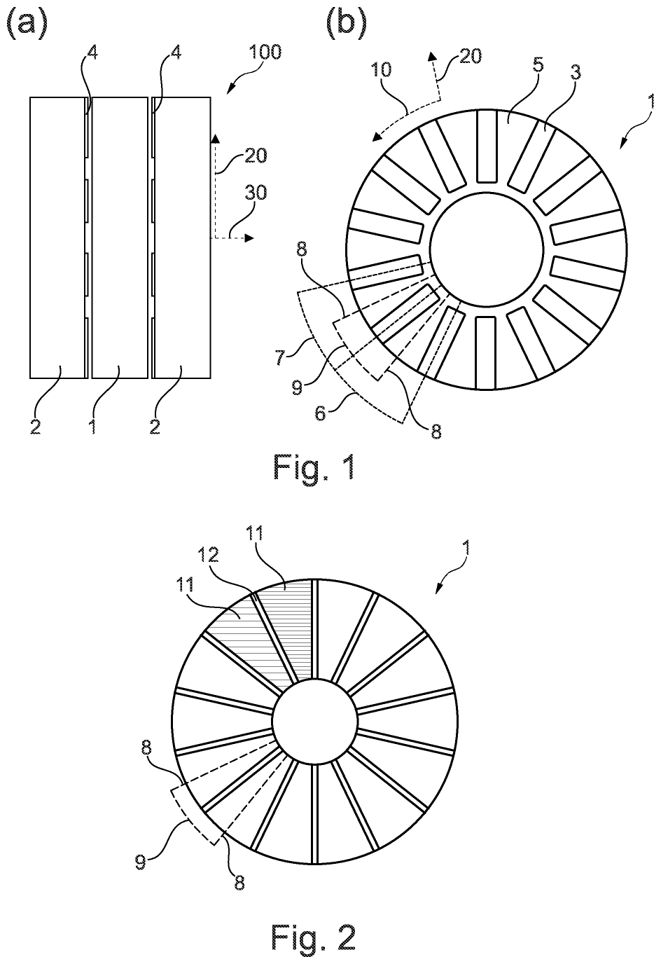

FIG. 1 (a) shows an exemplary embodiment of an electric axial flux machine 100 according to the disclosure in a schematic representation. The electric axial flux machine 100 is provided here as an internal rotor and has a rotor 1, which is arranged in an axial direction 30 between two stators 2 of the electric axial flux machine 100, Teeth 4 of the stators 2 can be seen here, which are uniformly distributed in the circumferential direction (see FIG. 1 (b)) of the electric axial flux machine 100. For reasons of perspective, it cannot be seen here that the stators 2 of the embodiment shown here each have 12 teeth 4. The view shown here is a side view. A radial direction 20 is also shown.

Electric axial flux machines 100 typically suffer from pole sensitivity, also known to those skilled in the art as cogging, which leads to uneven running of the electric axial flux machine 100. Here, a relative movement of the stator 1 and rotor 2, which involves pulling the magnetic poles (see FIG. 1 (b)) past the teeth 4, causes a varying magnetic resistance and thus a varying driving force.

FIG. 1 (b) shows a rotor 1 of a first exemplary embodiment of an electric axial flux machine 100 according to the disclosure in a schematic representation. The rotor 1 has magnetic poles 8, which are formed by the interaction of two adjacent permanent magnets 3 embedded in a main part 5 of the rotor 1, which are magnetized in the circumferential direction of the rotor 1. The permanent magnets 5 generate a magnetic flux in the circumferential direction of the rotor 1, which emerges from the two end faces of the disc-shaped rotor 1, In this respect, the magnetic pole 8 is defined by a position between two adjacent permanent magnets 5 of the rotor 1. The pole width 6, 7 of such a magnetic pole is defined by the distance between adjacent permanent magnets 5. By cleverly arranging the magnetic poles 3, in particular their pole widths 6, 7, in the circumferential direction 10 of the electric axial flux machine 100, cogging can be significantly reduced.

The magnetic poles 8 are arranged in the circumferential direction 10 with a uniform pole pitch 9 and alternately have a first pole width 6 and a second pole width 7. The first pole width 6 is 360°/p+(360°/LCM)*0.5. The second pole width is 7 360°/p−(360°/LCM)*0.5. P is the number of magnetic poles 8, i.e., 14 in the exemplary embodiment shown, and LCM is the least common multiple of the number of teeth per stator (see FIG. 1 (a)), here 12 teeth per stator, and of the number of magnetic poles 8. The least common multiple of the number of teeth per stator and of the number of magnetic poles 8 is 84 in the exemplary embodiment shown here. This results in the pole widths 6, 7 of 27.85° and 23.57°, which have the magnetic poles 8 alternating in the circumferential direction 10.

Owing to the alternating pole width 6, 7, the cogging torque, which leads to the unsteady running of the electric axial flux machine 100, is divided into two cogging torques, which cancel each other out in total.

The magnetic poles 8 are designed here as cuboid permanent magnets of the same size. The cuboid permanent magnets are arranged in recesses in a main part 5 of the rotor 1 and extend in a spoke-like manner in the radial direction 20. The main part 5 is used to guide the magnetic flux and is preferably made from Somaloy® as a pressed part.

FIG. 2 shows a second exemplary embodiment of an electric axial flux machine according to the disclosure, in particular its rotor 1. According to this exemplary embodiment, the magnetic poles 8 are formed by circular ring sector-shaped permanent magnets 11 arranged at an end face of the rotor 1. A gap 12 is provided between adjacent permanent magnets, in which the main part 5 of the rotor 1 is not occupied by a permanent magnet. The permanent magnets are magnetized in the axial direction 30, i.e., parallel to the axis of rotation of the rotor 1. In this respect, the magnetic poles 8 of the rotor 1 are each formed by a permanent magnet 11. The pole width 6, 7 therefore corresponds to the width of the permanent magnet in the circumferential direction 10 of the stator 1.

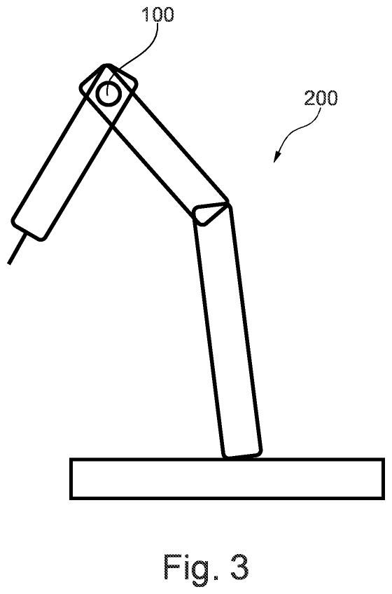

FIG. 3 shows an exemplary embodiment of a collaborative robot 200 according to the disclosure in a schematic representation. The collaborative robot 200 includes an electric axial flux machine 100 according to a preferred embodiment of the present disclosure. The quiet running of the electric axial flux machine 100 enables the collaborative robot 200 to work with high precision.

### LIST OF REFERENCE SIGNS

1 Rotor
2 Stator
3 Permanent magnet
4 Tooth
5 Main part
6 First pole width
7 Second pole width
8 Magnetic pole
9 Pole pitch
10 Circumferential direction
11 Permanent magnets
12 Gap
20 Radial direction
30 Axial direction

1. An electric axial flux machine comprising:
a disc-shaped rotor having a main part and having P magnetic poles, which are each arranged spaced apart in a circumferential direction of the main part by an identical pole pitch, and
a disc-shaped stator with Z teeth,
wherein the P magnetic poles are arranged in an alternating manner in the circumferential direction with a first pole width and a second pole width.

2. The electric axial flux machine according to claim 1, wherein the first pole width is in a range of 0.9[360°/p+(360°/LCM)*0.5] to 1.1[360°/p+(360°/LCM)*0.5] and the second pole width is in a range of 0.9[360°/p−(360°/LCM)*0.5] to 1.1[360°/p−(360°/LCM)*0.5], wherein P is greater than or equal to 4 and U is greater than or equal to 4 and not equal to P, and LCM is the least common multiple of P and Z.

3. The electric axial flux machine according claim 1, wherein the magnetic poles are formed by permanent magnets embedded in the main part of the rotor, wherein the permanent magnets have magnetization in the circumferential direction of the rotor.

4. The electric axial flux machine according to claim 1, wherein the magnetic poles are formed by permanent magnets arranged at an end face of the rotor.

5. The electric axial flux machine according to claim wherein the main part comprises a pressed part.

6. The electric axial flux machine according to claim 1, wherein the main part comprises an iron core.

7. The electric axial flux machine according to claim 3, wherein the magnetic poles comprise cuboid magnets.

8. The electric axial flux machine according to claim 7, wherein the cuboid magnets are arranged in a spoke-like manner in the main part.

9. The electric axial flux machine according to claim 7, wherein all of the cuboid magnets are the same size.

10. A collaborative robot comprising: an electric axial flux machine, wherein the electric axial flux machine includes a disc-shaped rotor having a main part and having P magnetic poles, which are each arranged spaced apart in a circumferential direction of the main part by an identical pole pitch, and
a disc-shaped stator with Z teeth,
wherein the P magnetic poles are arranged in an alternating manner in the circumferential direction with a first pole width and a second pole width.

11. The collaborative robot according to claim 9, wherein the first pole width is in a range of 0.9[360°/p+(360°/LCM)*0.5]to 1.1[360°/p+(360°/LCM)*0.5]and the second pole width is in a range of 0.9[360°/p−(360°/LCM)*0.5] to 1.1 [360°/p−(360°/LCM)*0.5].
wherein P is greater than or equal to 4 and U is greater than or equal to 4 and not equal to P, and LCM is the least common multiple of P and Z.

12. The collaborative robot according to claim 9, wherein the magnetic poles are formed by permanent magnets embedded in the main part of the rotor, wherein the permanent magnets have magnetization in the circumferential direction of the rotor.

13. The collaborative robot according to claim 9, wherein the magnetic poles are formed by permanent magnets arranged at an end face of the rotor.

14. The collaborative robot according to claim 9, wherein the main part comprises a pressed part.

15. The collaborative robot according to claim 9, wherein the main part comprises an iron core.

16. The collaborative robot according to claim 14, wherein the magnetic poles comprise cuboid magnets.

17. The collaborative robot according to claim 15, wherein the cuboid magnets are arranged in a spoke-like manner in the main part.

18. The collaborative robot according to claim 15, wherein all of the cuboid magnets are the same size.
